(19) United States
(12) Patent Application Publication
(10) Pub. No.: US 2008/0220313 A1
(43) Pub. Date: Sep. 11, 2008

(54) Seal arrangement comprising a metallic braze for a high-temperature fuel cell stack and a method of manufacturing a fuel cell stack

(75) Inventors: Hans-Rainer Zerfass, Taunsstein (DE); Armin Diez, Lenningen (DE); Peter Schenk, Hohenstein (DE); Wolfgang Fritz, Metzingen (DE)

Correspondence Address: Edward J. Timmer, P.O. Box 770, Richland, MI, 49083, US

(73) Assignee: ElringKlinger AG

(21) Appl. No.: 12/070,970

(22) Filed: Feb. 22, 2008

Related U.S. Application Data
(63) Continuation of application No. PCT/EP2006/009415, filed on Sep. 28, 2006.

(30) Foreign Application Priority Data
Sep. 29, 2005 (DE) 10 2005 048 213.9

(51) Int. Cl. H01M 8/02; B23K 1/00

(52) U.S. Cl. 429/36; 228/121

(57) ABSTRACT

In order to produce a seal arrangement for a fuel cell stack which comprises a plurality of fuel cell units that succeed one another in a stack direction wherein each of the fuel cell units comprises a housing incorporating at least one housing part consisting of a metallic material such that it exhibits an adequate electrically insulating effect and adequate mechanical rigidity even at a high operating temperature of the fuel cell stack, it is proposed that the seal arrangement comprises at least one housing part of a first fuel cell unit consisting of a metallic material which is provided with a coating of a ceramic material, wherein the housing part of the first fuel cell unit is brazed to a housing part of a second fuel cell unit by means of a metallic braze at least one position that is provided with the ceramic coating.

### RELATED APPLICATION

This application is a continuation application of PCT/EP 2006/009415 filed Sep. 28, 2006, the entire specification of which is incorporated herein by reference.

### FIELD OF DISCLOSURE

The present invention relates to a seal arrangement for a fuel cell stack which comprises a plurality of fuel cell units that succeed one another in a stack direction, wherein each of the fuel cell units comprises a housing incorporating at least one housing part consisting of a metallic material.

### BACKGROUND

For the purposes of setting the desired operating voltage, the necessary number of fuel cell units are arranged one upon the other in order to thereby obtain a fuel cell stack. In order to prevent an electrical short-circuit, the housings of the successive fuel cell units in the fuel cell stack must be electrically insulated from one another. Moreover, it is necessary to separate the fuel gas channels of the fuel cell stack from the oxidizing agent chambers of the fuel cell units in a gas-tight manner and to separate the oxidizing agent channels of the fuel cell stack from the fuel gas chambers of the fuel cell units in a gas-tight manner.

In the case of known fuel cell stacks, sealing and insulating elements consisting of a glass solder or of ceramic sealing materials are used in order to produce the requisite electrically insulating effect and the requisite sealing effect.

In the case of some of the usually used sealing materials, the electrical resistance at the operating temperature of a high temperature fuel cell unit (in the range of approximately 800° C. to approximately 900° C.) is no longer high enough for achieving a satisfactory insulating effect. Furthermore, some of the usually used sealing materials only exhibit a low level of stability for the changes in temperature (between the operating and quiescent phases) that frequently occur in a high temperature fuel cell unit.

### SUMMARY OF THE INVENTION

The object of the present invention is to produce a seal arrangement for a fuel cell stack of the type mentioned hereinabove which exhibits an adequate electrically insulating effect and adequate mechanical rigidity even at a high operating temperature of the fuel cell stack.

In accordance with the invention, this object is achieved in the case of a seal arrangement comprising the features of the preamble of Claim 1 in that the seal arrangement comprises at least one housing part of a first fuel cell unit consisting of a metallic material which is provided with a coating of a ceramic material, wherein the housing part of the first fuel cell unit is brazed to a housing part of a second fuel cell unit by means of a metallic braze at least one position that is provided with the ceramic coating.

By virtue of the solution in accordance with the invention, the housing part of the first fuel cell unit is brazed directly to the housing part of the second fuel cell unit without a separate intermediate element being arranged therebetween. A particularly simple structure for the fuel cell stack is thereby obtained.

The metallic braze is solid at the operating temperature of the fuel cell stack.

Likewise, the housing part of the second fuel cell unit, to which the housing part of the first fuel cell unit that is provided with the ceramic coating is brazed, is preferably formed from a metallic material.

In addition, the housing part of the second fuel cell unit, to which the housing part of the first fuel cell unit that is provided with the ceramic coating is brazed, can be provided with an electrically insulating ceramic coating.

In principle however, it is sufficient if one of the housing parts connected together by the brazing process comprises such an electrically insulating ceramic coating in order to ensure the electrical insulating effect of the seal arrangement.

The ceramic coating is formed from a ceramic material which exhibits an electrical insulating effect at the operating temperature of the fuel cell stack so that the electrical insulation of the mutually successive fuel cell units in the fuel cell stack is ensured by this ceramic coating.

Since the electrical insulation is already provided by the ceramic coating, a metallic braze which is stable at high temperatures and highly adaptable to changes in temperature can be used for the mechanical connections between the housings of successive fuel cell units and for the sealing of the fluid channels instead of a glass solder or a ceramic sealing material.

Moreover, the concept in accordance with the invention permits a durable connection between the housings of the fuel cell units that are mutually successive in the stack direction to be produced in a simple manner so that the build-up of the fuel cell stack can be effected in a particularly simple and rapid manner by successively bonding the fuel cell units to one another.

In a preferred embodiment of the invention, provision is made for the housing part of the first fuel cell unit to comprise at least one fuel gas passage opening.

As an alternative or in addition thereto, provision may be made for the housing part of the first fuel cell unit to comprise at least one oxidizing agent passage opening.

Furthermore, provision may be made for the housing part of the first fuel cell unit to comprise at least one passage opening through which, in the assembled state of the fuel cell stack, a cathode electrolyte anode unit of the first fuel cell unit is accessible for enabling electrical contact to be made by another fuel cell unit of the fuel cell stack.

As an alternative or in addition thereto, provision may also be made for the housing part of the first fuel cell unit to comprise at least one contact element for the purposes of making electrical contact with a neighbouring cathode electrolyte anode unit.

Furthermore, provision may be made for a cathode electrolyte anode unit of the fuel cell unit to be fixed, either directly or via a substrate of the cathode electrolyte anode unit, to the housing part of the first fuel cell unit, for example, by brazing and/or by welding.

The process of producing the housing parts of the first fuel cell unit is made particularly simple if the housing part is formed from a metal sheet.

Preferably, provision is made for the housing part of the first fuel cell unit to be formed from a highly corrosion resistant steel. In consequence, adequate corrosion resistance of the housing part is obtained even at the high operating temperature of an SOFC (Solid Oxide Fuel Cell) fuel cell unit.

It is particularly expedient, if the corrosion resistant steel which is commercially available under the trade name “Aluchrom Y” or else “FeCrAlY” is used as the material for the housing part.

In principle, the ceramic coating can be formed from any ceramic material which has a sufficiently high specific electrical resistance at the operating temperature of the fuel cell stack.

Ceramic coatings such as those comprising aluminium oxide and/or titanium dioxide and/or zirconium dioxide and/or magnesium oxide are particularly suitable.

The ceramic coating can be produced for example by a thermal spraying process, in particular by an atmospheric plasma spraying process, by a vacuum plasma spraying process or by a flame spraying process.

In a special embodiment of the seal arrangement in accordance with the invention, provision is made for the housing part of the first fuel cell unit to be formed from a metallic alloy which contains an oxidizable constituent.

In particular, provision may be made for the metallic alloy to contain aluminium and/or zirconium as the oxidizable constituent.

When an oxidizable constituent is present in the metallic alloy from which the housing part is formed, the ceramic coating can be produced by oxidation of the oxidizable constituent, for example, aluminium and/or zirconium of the metallic alloy.

Preferably, the ceramic coating has a thickness of approximately 20 μm to approximately 1000 μm.

A silver based braze in particular can be used for brazing the ceramic coating of the housing part of the first fuel cell unit to the housing part of the second fuel cell unit.

Such a silver based braze can be used with or without an additive of copper.

If the silver based braze without a copper additive is used, then it is expedient for the silver based braze to contain an additive of copper oxide since the silver based braze will better wet ceramic surfaces due to the additive of copper oxide.

Furthermore, the silver based braze can comprise a titanium additive so as to improve the wetting properties.

The braze used for brazing the ceramic coating of the housing part of the first fuel cell unit to the housing part of the second fuel cell unit is made from an intimate mixture of the components from which the braze alloy will only form in situ when heated up to the brazing temperature.

Furthermore, an active braze can also be used for brazing the ceramic coating on the housing part of the first fuel cell unit to the housing part of the second fuel cell unit.

Active brazes are metallic alloys which contain boundary-surface active elements (e.g. titanium, zirconium, hafnium, niobium and/or tantalum) in small quantities and are thus able to lower the boundary surface energy between a ceramic material and the braze melt to such an extent that wetting of the ceramic material by the braze can take place.

The active brazing technique using active brazes enables ceramic-ceramic/metal compounds to be produced in the course of a single-step bonding process without a preceding step of metallizing the ceramic jointing surfaces. The wetting of the ceramic jointing surfaces by the braze is thus ensured by virtue of using the active braze.

A suitable active braze is sold under the name “Copper ABA” by the company Wesgo Metals, 610 Quarry Road, San Carlos, Calif. 94070, USA for example.

This active braze has the following composition: 2 percentage weight Al; 92.7 percentage weight Cu; 3 percentage weight Si; 2.3 percentage weight Ti.

The at least one position of the housing part of the second fuel cell unit at which the housing part of the second fuel cell unit is brazed to the housing part of the first fuel cell unit can likewise be provided with an electrically insulating ceramic coating. However, due to the fact that the electrical insulation between the housings of the mutually successive fuel cell units is already ensured by the ceramic coating on the housing part of the first fuel cell unit, such a ceramic coating on the housing part of the second fuel cell unit is not of overwhelming necessity.

In a preferred embodiment of the invention, provision is made for the housing part of the first fuel cell unit that is provided with the ceramic coating to be fixed to a second housing part of the first fuel cell unit, i.e. the selfsame fuel cell unit.

In particular, provision may be made for the housing part of the first fuel cell unit that is provided with the ceramic coating to be welded and/or brazed to the second housing part of the first fuel cell unit. A particularly durable and rapidly and simply producible connection between the housing parts of the first fuel cell unit can be obtained in this way.

The number of constructional elements necessary for the production of the fuel cell stack is reduced in an advantageous manner if provision is made for the second housing part of the first fuel cell unit to have substantially the same shape as the housing part of the second fuel cell unit to which the housing part of the first fuel cell unit that is provided with the ceramic coating is brazed.

The second housing part of the first fuel cell unit can, in particular, comprise at least one fuel gas passage opening.

As an alternative or in addition thereto, provision may be made for the second housing part of the first fuel cell unit to comprise at least one oxidizing agent passage opening.

Furthermore, the second housing part of the first fuel cell unit may comprise at least one contact element for the purposes of making electrical contact with a neighbouring cathode electrolyte anode unit.

As an alternative or in addition thereto, provision may also be made for the second housing part of the first fuel cell unit to comprise at least one passage opening through which, in the assembled condition of the fuel cell stack, a cathode electrolyte anode unit of the first fuel cell unit is accessible for enabling electrical contact to be made by another fuel cell unit of the fuel cell stack.

Furthermore, provision may be made for a cathode electrolyte anode unit of the fuel cell unit to be fixed to the second housing part of the first fuel cell unit either directly or via a substrate of the cathode electrolyte anode unit, for example, by brazing and/or by welding.

In a preferred embodiment of the invention, provision is made for the first housing part of the first fuel cell unit that is provided with the ceramic coating together with the second housing part of the first fuel cell unit that is connected to this housing part to form a complete two-piece housing of the first fuel cell unit without the need for further and especially metallic housing parts.

This housing can enclose, in particular, a cathode electrolyte anode unit of the first fuel cell unit between the two housing parts.

The further object of the present invention is to provide a method for manufacturing a fuel cell stack which comprises a plurality of fuel cell units that succeed one another in a stack direction wherein each of the fuel cell units comprises a housing incorporating at least one housing part consisting of a metallic material, said method enabling the housings of the fuel cell units to be connectable to one another in such a manner that an adequate electrical insulating effect, adequate gas-tightness and adequate mechanical rigidity are ensured even at a high operating temperature.

In accordance with the invention, this object is achieved by a method which comprises the following process steps:
preparing a housing part of a first fuel cell unit from a metallic material which is provided with a coating of a ceramic material;
brazing the housing part of the first fuel cell unit to a housing part of a second fuel cell unit by means of a metallic braze at least one position that is provided with the ceramic coating.

Particular embodiments of the method in accordance with the invention form the subject matter of Claims 25 to 28, the advantages thereof having already been explained in connection with the special embodiments of the seal arrangement in accordance with the invention.

Further features and advantages of the invention form the subject matter of the following description and the graphic illustration of an exemplary embodiment.

### BRIEF DESCRIPTION OF THE DRAWINGS

FIG. 1 shows a schematic exploded illustration of the elements of a fuel cell unit;

FIG. 2 a schematic exploded illustration of the fuel cell unit of FIG. 1, after a CEA unit of the fuel cell unit has been brazed to an upper housing part of the fuel cell unit;

FIG. 3 a schematic exploded illustration of the fuel cell unit of FIG. 2, after the upper housing part and a lower housing part have been welded together, and a further second fuel cell unit of similar construction which is arranged above this first fuel cell unit in the stack direction of a fuel cell stack;

FIG. 4 a schematic perspective illustration of the two fuel cell units of FIG. 3, after the upper housing part of the first fuel cell unit has been brazed to the lower housing part of the second fuel cell unit;

FIG. 5 a schematic plan view of a fuel cell stack from above;

FIG. 6 a partially sectional detailed perspective view of the fuel cell stack in the region of an oxidizing agent channel;

FIG. 7 a schematic vertical section through the fuel cell stack in the region of the oxidizing agent channel, along the line 7-7 in FIG. 5;

FIG. 8 an enlarged exploded illustration of the region I in FIG. 7; and

FIG. 9 a schematic vertical section through the fuel cell stack in the region of a fuel gas channel, along the line 9-9 in FIG. 5.

Similar or functionally equivalent elements are designated by the same reference symbols in each of the Figures.

### DETAILED DESCRIPTION OF THE INVENTION

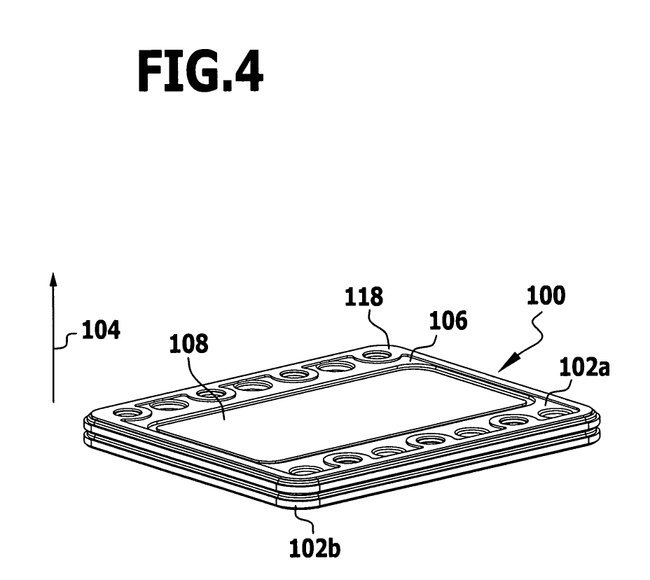

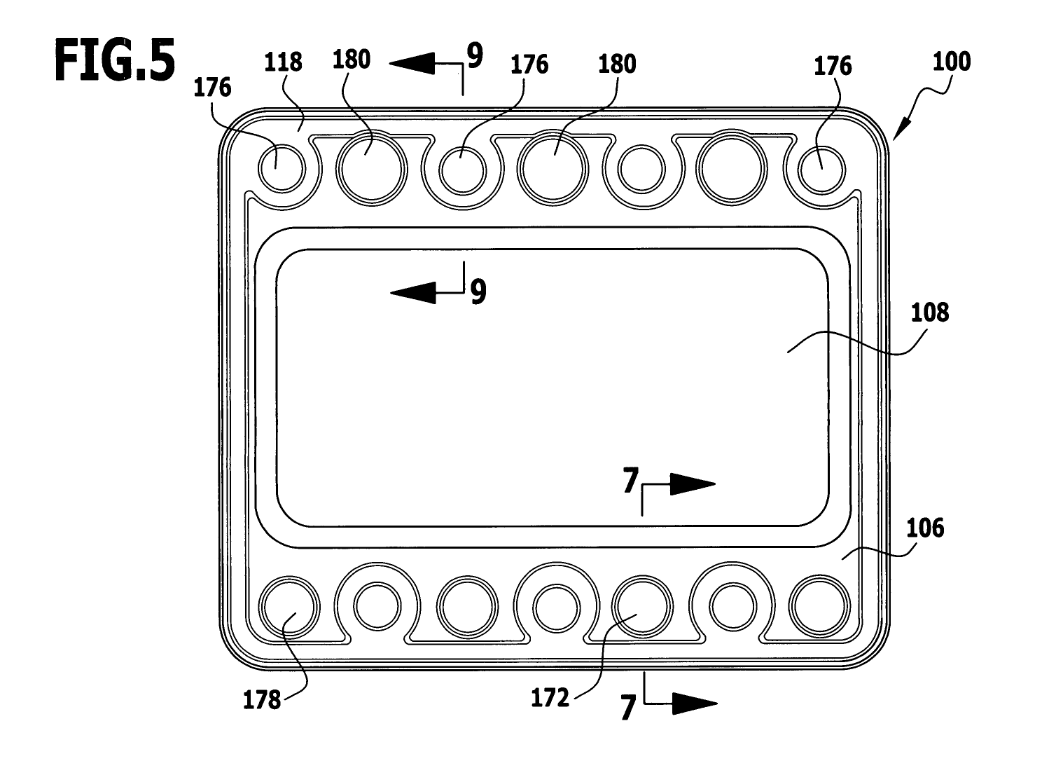

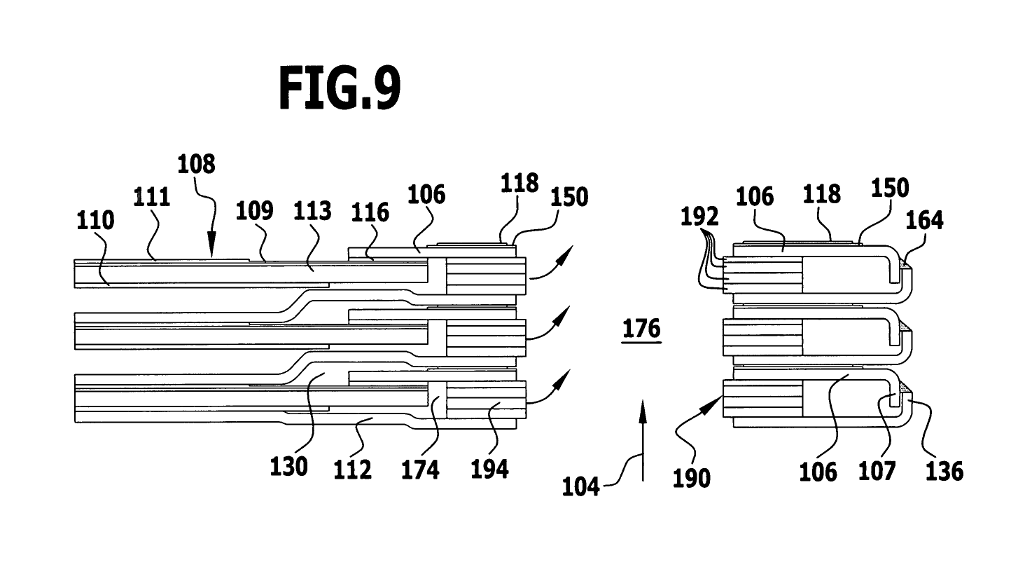

A fuel cell stack bearing the general reference 100 that is illustrated in FIGS. 4 to 9 comprises a plurality of fuel cell units 102 which are each of identical construction and are stacked one on top of the other along a vertical stack direction 104.

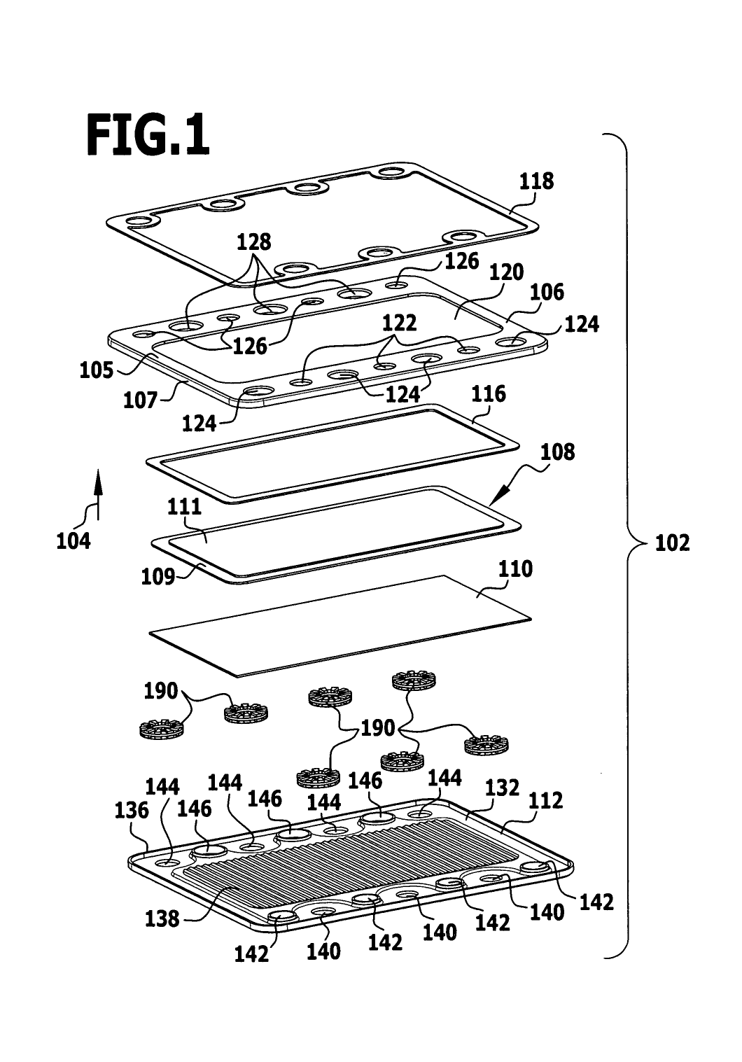

Each of the fuel cell units 102 comprises the components illustrated individually in FIG. 1, namely, an upper housing part 106, a cathode electrolyte anode unit (CEA unit) 108, a contact material 110, a lower housing part 112 and spacer rings 190.

Furthermore, a first braze layer 116 for brazing the CEA unit 108 to the upper housing part 106 and a second braze layer 118 for brazing the upper housing part 106 to the lower housing part 112 of a second fuel cell unit 102 located thereabove is illustrated in FIG. 1.

The upper housing part 106 is in the form of a shaped metal sheet and comprises a substantially rectangular and substantially flat metal plate 105 which is provided with a substantially rectangular central passage opening 120 through which, in the fully assembled state of the fuel cell unit, the CEA unit 108 of the fuel cell unit 102 is accessible for contact-making purposes by the lower housing part 112 of the fuel cell unit 102 located thereabove in the stack direction 104.

On the one side of the passage opening 120, the upper housing part 106 is provided with a plurality of, three for example, fuel gas supply openings 122 which are arranged to alternate with a plurality of, four for example, oxidizing agent supply openings 124.

On the opposite side of the passage opening 120, the upper housing part 106 is provided with a plurality of, four for example, fuel gas removal openings 126 which are arranged to alternate with a plurality of, three for example, oxidizing agent removal openings 128.

At the outer edge thereof, the metal plate 105 merges into an edge flange 107 which is aligned substantially parallel to the stack direction 104.

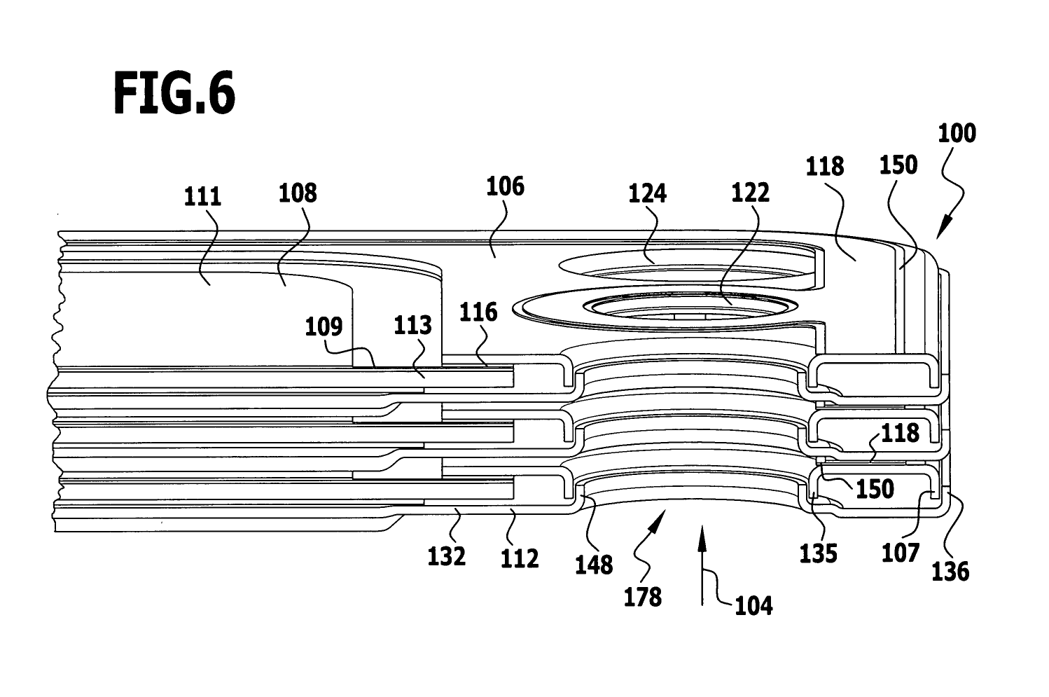

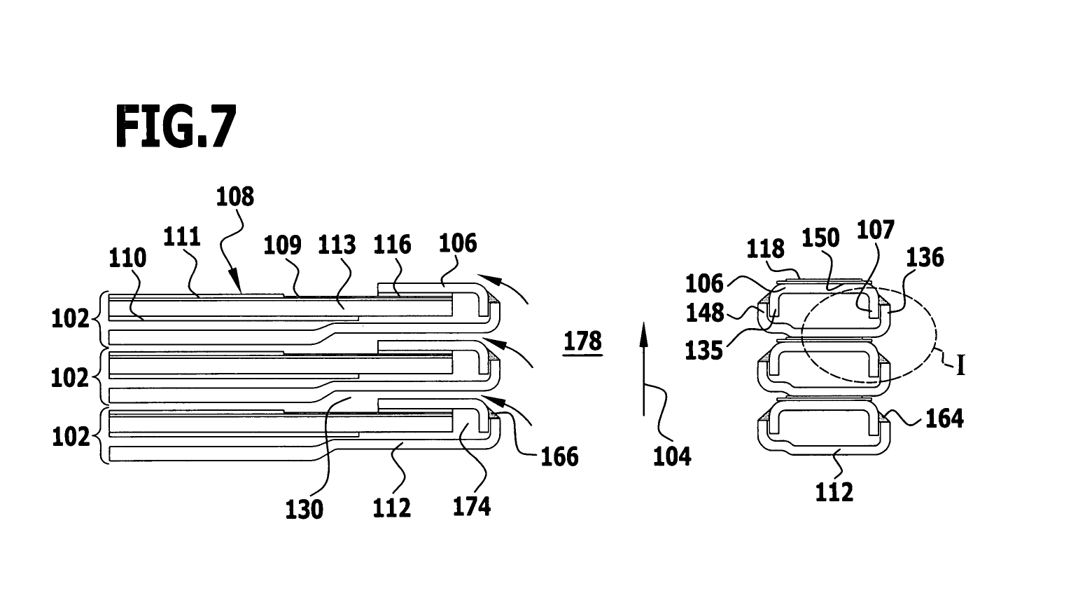

The oxidizing agent supply openings 124 and the oxidizing agent removal openings of the upper housing part 106 are surrounded in each case by a ring flange 135 which surrounds the opening concerned in ring-like manner and is aligned substantially parallel to the stack direction 104 (see FIGS. 6 and 7).

The upper housing part 106 is preferably made of a highly corrosion resistant steel, for example, from the alloy Crofer 22.

The material Crofer 22 has the following composition:

22 percentage weight chromium, 0.6 percentage weight aluminium, 0.3 percentage weight silicon, 0.45 percentage weight manganese, 0.08 percentage weight titanium, 0.08 percentage weight lanthanum, the remainder iron.

This material is sold by the company ThyssenKrupp VDM GmbH, Plettenberger Straβe 2, 58791 Werdohl, Germany.

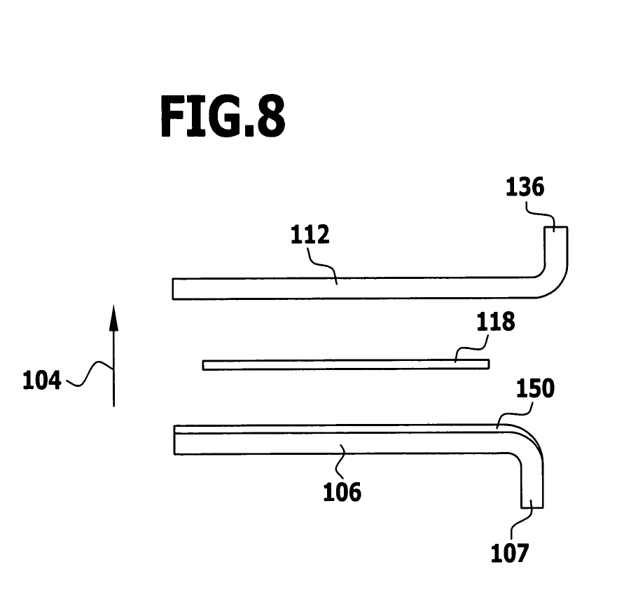

As can be seen from FIG. 8, the upper housing part 106 is provided on the upper surface thereof facing the lower housing part 112 of a neighbouring fuel cell unit 102 with a ceramic coating 150 consisting of a ceramic material which has an electrically insulating effect at the operating temperature of the fuel cell unit 102.

The ceramic coating 150 on the upper housing part 106 may extend over the entire upper surface of the upper housing part 106 or merely over only those positions at which the upper housing part 106 is brazed to the lower housing part 112 of the fuel cell unit 102 located thereabove.

This electrically insulating ceramic coating 150 is applied by means of a thermal spraying process to produce a layer thickness of, for example, approximately 30 μm up to, for example, approximately 500 μm.

Processes that are suitable for this purpose are, for example, the atmospheric plasma spraying process, the vacuum plasma spraying process or the flame spraying process.

The following insulating materials which can be applied by a thermal spraying process are suitable as the material for the ceramic coating 150 for example:
99.5% aluminium oxide;
a mixture consisting of 97 percentage weight aluminium oxide and 3 percentage weight titanium dioxide;
yttrium-stabilized zirconium dioxide 5YSZ or 8YSZ;
a mixture of 70 percentage weight aluminium oxide and 30 percentage weight magnesium oxide;
an aluminium magnesium spinel.

As an alternative to an upper housing part 106 having a ceramic insulating layer that was applied by a thermal spraying process, use can also be made of an upper housing part 106 consisting of a highly corrosion resistant steel containing aluminium that has been provided with a ceramic coating 150 of aluminium oxide by pre-oxidation of the aluminium-containing metallic material.

In particular, such an upper housing part 106 can be formed from the steel alloy which is known by the name of “FeCrAlY” or else “Aluchrom Y”.

The composition of the FeCrAlY alloy is as follows: 30 percentage weight chromium, 5 percentage weight aluminium, 0.5 percentage weight yttrium, the remainder iron.

The upper housing part 106 which is stamped out from a metal sheet of this steel alloy and subjected to shaping processes is placed in an oxygen-containing atmosphere (in air for example) and held at a temperature of approximately 1100° C. for a period of time of two hours for example. As a result of this temperature treatment in an oxygen-containing atmosphere, the ceramic coating 150 consisting of aluminium oxide is produced on the upper surface of the upper housing part 106.

The CEA unit 108 comprises an anode 113, an electrolyte 109 which is arranged above the anode 113 and a cathode 111 which is arranged above the electrolyte 109.

The anode 113 is formed from a ceramic material, from ZrO₂ or from a NiZrO₂-Cermet (ceramic metal mixture) for example, which is electrically conductive at the operating temperature of the fuel cell unit (from approximately 800° C. to approximately 900° C.) and is porous in order to enable a fuel gas to pass through the anode 113 to the electrolyte 109 adjoining the anode 113.

A hydrocarbon-containing gas mixture or pure hydrogen can be used as the fuel gas for example.

The electrolyte 109 is preferably in the form of a solid electrolyte, in particular, a solid oxide electrolyte, and consists of yttrium-stabilized zirconium dioxide for example. The electrolyte 109 is electronically non-conductive at normal temperatures and also at the operating temperature. By contrast however, the ionic conductivity thereof rises with increasing temperature.

The cathode 111 is formed from a ceramic material which is electrically conductive at the operating temperature of the fuel cell unit, for example, from (La_{0.8}Sr_{0.2})_{0.98}MnO₃, and it is porous in order to enable an oxidizing agent, air or pure oxygen for example, to pass to the electrolyte 109 from an oxidizing agent chamber 130 adjoining the cathode 111.

The gastight electrolyte 109 of the CEA unit 108 extends up to the edge of the gas-permeable anode 113, whereby the cathode surface is smaller than the surface of the anode so that the boundary region of the electrolyte 109 can be brazed to the upper housing part 106.

The contact material 110 that is arranged between the CEA unit 108 and the lower housing part 112 can be in the form of a net, a woven material or a fleece made of nickel wire for example.

The lower housing part 112 is in the form of a sheet-metal shaped part and comprises a substantially rectangular plate 132 which is aligned perpendicularly to the stack direction 104 and merges at the edges thereof into an edge flange 136 which is aligned substantially in parallel with the stack direction 104.

The plate 132 comprises a substantially rectangular central contact field 138 which is provided with contact elements for enabling contact to be made with the contact material 110 on the one hand and the cathode 111 of a CEA unit 108 of a neighbouring fuel cell unit 102 on the other, said elements being of corrugated or pimpled shape for example.

On the one side of the contact field 138, the plate 132 is provided with a plurality of, three for example, fuel gas supply openings 140 which are arranged to alternate with a plurality of, four for example, oxidizing agent supply openings 142.

The fuel gas supply openings 140 and the oxidizing agent supply openings 142 of the lower housing part 112 are aligned with the respective fuel gas supply openings 122 and the oxidizing agent supply openings 124 of the upper housing part 106.

On the other side of the contact field 138, the plate 132 is provided with a plurality of, four for example, fuel gas removal openings 144 which are arranged to alternate with a plurality of, three for example, oxidizing agent removal openings 146.

The fuel gas removal openings 144 and the oxidizing agent removal openings 146 of the lower housing part 112 are aligned with the respective fuel gas removal openings 126 and with the oxidizing agent removal openings 128 of the upper housing part 106.

The oxidizing agent removal openings 146 are preferably located opposite the fuel gas supply openings 140, and the fuel gas removal openings 144 are preferably located opposite the oxidizing agent supply openings 142.

As can best be seen from FIGS. 6 and 7, the oxidizing agent supply openings 142 (in like manner to the oxidizing agent removal openings 146) of the lower housing part 112 are surrounded by a respective ring flange 148 which surrounds the opening concerned in ring-like manner and is aligned substantially parallel to the stack direction 104.

The lower housing part 112 is preferably made of a highly corrosion resistant steel, for example, from the previously mentioned alloy Crofer 22.

Furthermore, for the purposes of mechanical stabilization of the fuel cell unit 102, there are provided spacer rings 190 which are arranged in the region of the respective fuel gas supply openings 122 and 140 and in the region of the respective fuel gas removal openings 126 and 144 between the upper housing part 106 and the lower housing part 112 of the fuel cell unit 102 in order to maintain a spacing between the upper housing part 106 and the lower housing part 112 in this region.

Each of the spacer rings 190 consists of a plurality of superimposed metal layers 192, whereby fuel gas passage channels 194 that enable the passage of fuel gas through the spacer rings 190 are formed in the metal layers 192 by means of recesses.

In order to produce the fuel cell units 102 illustrated in FIG. 4 from the previously described individual components, one proceeds as follows:

Firstly, the lower housing part 112 is provided with the ceramic coating 150 in the previously described manner.

Subsequently, the electrolyte 109 of the CEA unit 108 is brazed along the edge of its upper surface to the upper housing part 106, namely, to the lower surface of the region of the upper housing part 106 surrounding the passage opening 120 in the upper housing part 106.

As illustrated in FIG. 1, the brazing material needed for this purpose can be inserted between the electrolyte 109 and the upper housing part 106 in the form of a suitably cut brazing foil 116 or else it could be deposited on the upper surface of the electrolyte 109 and/or on the lower surface of the upper housing part 106 in the form of a bead of brazing material by means of a dispenser. Furthermore, it is also possible for the brazing material to be applied to the upper surface of the electrolyte 109 and/or to the lower surface of the upper housing part 106 by means of a pattern printing process, for example, a silk-screen printing process.

A silver based braze incorporating a copper additive, for example a silver based braze with the composition (in mol %): Ag4Cu or Ag8Cu can be used as the brazing material.

The brazing process takes place in an air atmosphere. The brazing temperature amounts to 1050° C. for example, the duration of the brazing process is approximately 5 minutes for example. When the brazing process is effected in air, copper oxide forms in situ.

As an alternative thereto, a silver based braze without a copper additive could also be used as the brazing material. Such a copper-free braze offers the advantage of a higher solidus temperature (this amounts to approximately 960° C. without a copper additive, to approximately 780° C. with a copper additive). Since pure silver does not wet ceramic surfaces, copper(II) oxide is added to those silver based brazes without a copper additive for the purposes of reducing the edge angle. The brazing process utilising silver based brazes without a copper additive takes place in an air atmosphere or in an inert gas atmosphere, for example, under argon.

In this case too, the brazing temperature preferably amounts to approximately 1050° C., the duration of the brazing process to approximately 5 minutes for example.

As an alternative to brazing the CEA unit 108 into the upper housing part 106, provision could also be made for a substrate upon which the CEA unit 108 has not yet been produced to be welded to the upper housing part 106 and, following the welding process, the electro-chemically active layers of the CEA unit 108, i.e. the anode, electrolyte and cathode thereof, are produced successively on the substrate that has already been welded to the upper housing part 106 using a vacuum plasma spraying process.

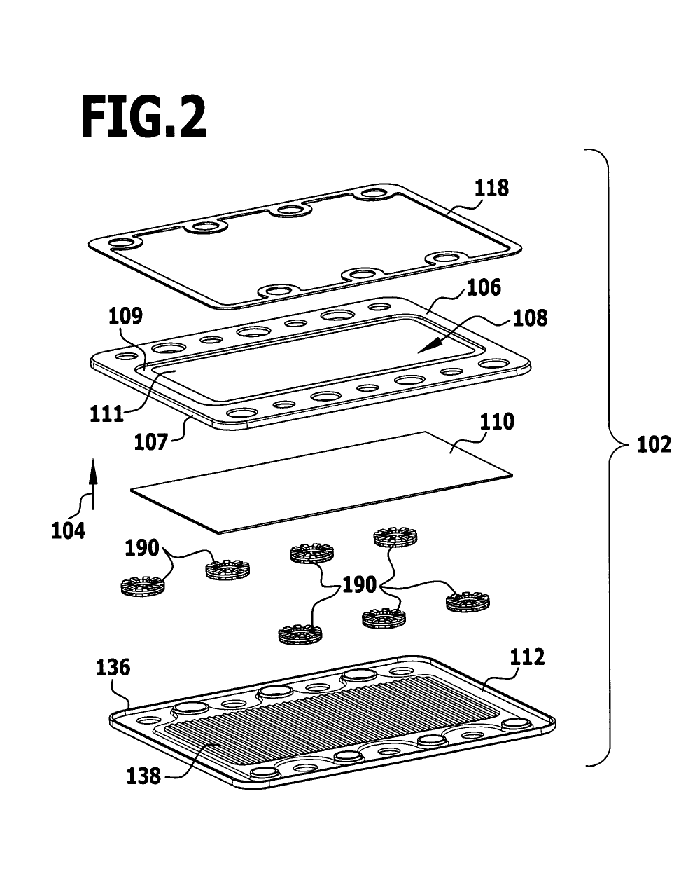

After the connection of the CEA unit 108 to the upper housing part 106, the state illustrated in FIG. 2 is reached.

Subsequently, the contact material 110 and the spacer rings 190 are inserted between the lower housing part 112 and the upper housing part 106 and, if necessary, brazed and/or welded to the lower housing part 112 and/or to the upper housing part 106, and then the lower housing part 112 and the upper housing part 106 are welded together in gas-tight manner along a welding seam 164 which extends around the outer edge of the edge flange 136 of the lower housing part 112 and the edge flange 107 of the upper housing part 106 and along welding seams 166 which extend around the inner edges of the ring flanges 148 of the lower housing part 112 and the ring flanges 135 of the oxidizing agent supply openings 124 and the oxidizing agent removal openings 128 of the upper housing part 106.

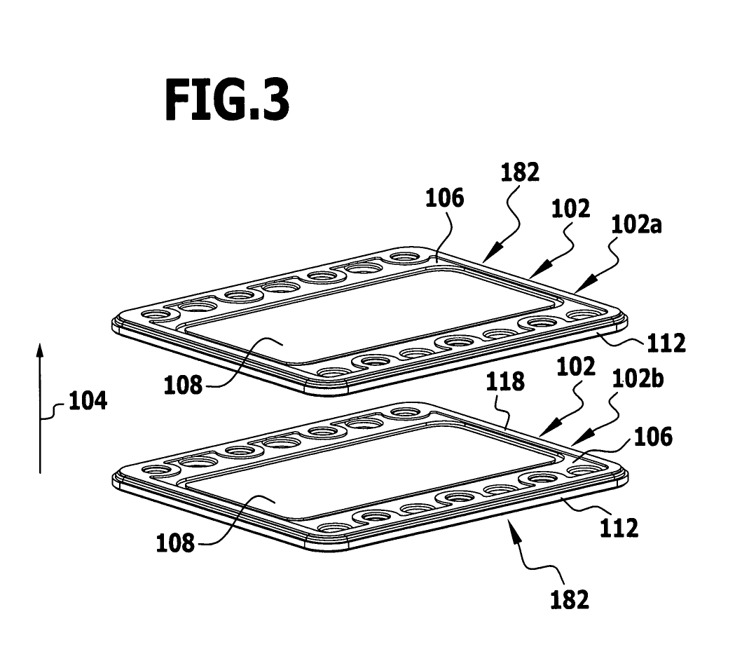

After this process step, the state illustrated in FIG. 3 is reached.

Now the side of the upper housing part 106 of the lower fuel cell unit 102b that is provided with the ceramic coating 150 and faces the lower housing part 112 of the upper fuel cell unit 102a is brazed directly by means of a brazing material to the side of the lower housing part 112 facing the upper housing part 106 whilst being weighted down.

Here, the selfsame brazing materials can be used as were described previously in connection with the process of brazing the CEA unit 108 and the upper housing part 106, and the brazing procedure can take place under the same conditions.

Thus in particular and as illustrated in FIG. 3, the brazing material needed for this purpose can be inserted in the form of a suitably cut brazing foil 118 between the upper housing part 106 of the lower fuel cell unit 102b and the lower housing part 112 of the upper fuel cell unit 102a, or else it could be applied in the form of a bead of brazing material to the upper surface of the upper housing part 106 and/or to the lower surface of the lower housing part 112 by means of a dispenser. Furthermore, it is also possible for the brazing material to be applied to the upper surface of the upper housing part 106 and/or to the lower surface of the lower housing part 112 by means of a pattern printing process, a silk-screen printing process for example.

A silver based braze with a copper additive can be used as the brazing material, for example, a silver based braze having the composition (in mol percent): Ag-4Cu or Ag-8Cu.

The brazing process takes place in an air atmosphere. The brazing temperature amounts to 1050° C. for example, the duration of the brazing process is approximately 5 minutes for example. Copper oxide forms in situ during the process of brazing in air.

As an alternative thereto, a silver based braze without a copper additive could also be used as the brazing material. Such a copper-free braze offers the advantage of a higher solidus temperature (this amounts to approximately 960° C. without a copper additive, to approximately 780° C. with a copper additive). Since pure silver does not wet ceramic surfaces, copper(II) oxide is added to those silver based brazes without a copper additive for the purposes of reducing the edge angle. The brazing process utilising silver based brazes without a copper additive takes place in an air atmosphere or in an inert gas atmosphere, for example, under argon.

Suitable silver based brazes without an additive of elementary copper have the composition (in mol percent): Ag-4CuO or Ag-8CuO for example.

An additive of titanium can serve for the further improvement of the wetting process (reduction of the edge angle). An intimate mixture of the appropriate components in powder form is used for the production of the brazes. The braze alloy is formed in situ from this mixture. The titanium is added to this mixture in the form of titanium hydride. A metallic titanium is formed from the hydride at approximately 400° C.

Suitable silver based brazes without an additive of elementary copper, but with an additive of titanium have the composition (in mol percent): Ag-4CuO-0.5Ti or Ag-8CuO-0.5Ti for example.

In this case too, the brazing temperature preferably amounts to approximately 1050° C., the duration of the brazing process to approximately 5 minutes for example.

Furthermore, active brazes can also be used as the brazing material for brazing the upper housing part 106 to the lower housing part 112.

Active brazes are metallic alloys which contain boundary-surface active elements (e.g. titanium, zirconium, hafnium, niobium and/or tantalum) in small quantities and are thus able to lower the boundary surface energy between a ceramic material and the braze melt to such an extent that wetting of the ceramic material by the braze can take place.

The active brazing technique using active brazes enables ceramic-ceramic/metal compounds to be produced in the course of a single-step bonding process without a preceding step of metallizing the ceramic jointing surfaces. The wetting of the ceramic jointing surfaces by the braze is thus ensured due to the use of an active braze.

A suitable active braze is sold under the name “Copper ABA” by the company Wesgo Metals, 610 Quarry Road, San Carlos, Calif. 94070, USA for example.

This active braze has the following composition: 2 percentage weight Al; 92.7 percentage weight Cu; 3 percentage weight Si; 2.3 percentage weight Ti.

The brazing process can be carried out, in particular, in accordance with the following temperature program:
Insofar as the braze material is applied in the form of a braze paste, the braze paste is dried for a period of approximately 10 minutes at a temperature of approximately 150° C.
Subsequently, brazing takes place in three steps, whereby in a first step, those components that are to be brazed together are heated up for one hour from room temperature to a temperature of approximately 300° C., in a following second stage, the components that are to be brazed are heated up within three hours from a temperature of approximately 300° C. to a temperature of approximately 550° C. and in a third step, the components that are to be brazed together are heated up within three hours from a temperature of approximately 550° C. to a final temperature of approximately 1,050° C., whereby the final temperature is maintained for a time period of approximately 5 minutes for example.
After brazing has been effected, the components that have been brazed together are cooled to room temperature over a long period of time, for example, over night.

In order to prevent an unwanted flow of the braze material beyond the region that is to be brazed, a braze stop material can be applied to those areas of the upper housing part 106 and the lower housing part 112 which should remain free of the braze material.

Suitable braze stop materials are sold under the designations “Stopyt Liquid” or “Stopyt Liquid # 62A” by the company Wesgo Metals, 610 Quarry Road, San Carlos, Calif. 94070, USA.

If the brazing process is effected in a vacuum or in an inert gas atmosphere, then care should be taken that the oxygen partial pressure does not drop below a certain lower limit since the cathode 111 of the CEA unit 108 will otherwise be destroyed.

In the case of a cathode consisting of lanthanum strontium manganate (LSM), the lower limit for the oxygen partial pressure amounts to approximately 1 ppm (10⁻⁴ bar); in the case of a cathode consisting of lanthanum strontium cobalt ferrite (LSCF) the lower limit for the oxygen partial pressure amounts to approximately 10 ppm (10⁻³ bar).

After the upper housing part 106 of the lower fuel cell unit 102b has been brazed to the lower housing part 112 of the upper fuel cell unit 102a, the state illustrated in FIG. 4 is reached.

After two fuel cell units 102 have been connected together in this way, the fuel cell stack 100 can be gradually built up by successively brazing further fuel cell units 102 to the upper housing part 106 of the upper fuel cell unit 102a or to the lower housing part 112 of the lower fuel cell unit 102b in the stack direction 104 until the desired number of fuel cell units 102 is attained.

In the finished fuel cell stack 100, the respective mutually aligned fuel gas supply openings 122 and 140 of the upper housing parts 106 and the lower housing parts 112 form a respective fuel gas supply channel 172 which, in each fuel cell unit 102, opens between the upper surface of the lower housing part 112 and the lower surface of the upper housing part 106 into a fuel gas chamber 174 which is formed between the upper surface of the contact field 138 of the lower housing part 112 on the one hand and the lower surface of the CEA unit 108 on the other.

The respective mutually aligned fuel gas removal openings 126 and 144 of the upper housing parts 106 and the lower housing parts 112 form a respective fuel gas removal channel 176 which is open to the fuel gas chamber 174 in the region between the upper surface of the lower housing part 112 and the lower surface of the upper housing part 106 on the side of each fuel cell unit 102 that is located opposite the fuel gas supply channels 172.

The respective mutually aligned oxidizing agent supply openings 124 and 142 of the upper housing parts 106 and the lower housing parts 112 together form a respective oxidizing agent supply channel 178 which is open to the oxidizing agent chamber 130 of the fuel cell unit 102 in the region of each fuel cell unit 102 between the upper surface of the upper housing part 106 and the lower surface of the lower housing part 112 of the fuel cell unit 102 located thereabove in the stack direction 104.

In like manner, the respective mutually aligned oxidizing agent removal openings 128 and 146 of the upper housing parts 106 and the lower housing parts 112 form a respective oxidizing agent removal channel 180 which is arranged on the side of the fuel cell units 102 located opposite to the oxidizing agent supply channels 178 and likewise opens into the oxidizing agent chamber 130 of the fuel cell unit 102 in the region of each fuel cell unit 102 between the upper surface of the upper housing part 106 and the lower surface of the lower housing part 112 of the fuel cell unit 102 located thereabove in the stack direction 104.

In operation of the fuel cell stack 100, a fuel gas is supplied to the fuel gas chamber 174 of each fuel cell unit 102 by way of the fuel gas supply channels 172 and the exhaust gas produced by oxidation at the anode 113 of the CEA unit 108 as well as any unused fuel gas is removed from the fuel gas chamber 174 through the fuel gas removal channels 176.

In like manner, an oxidizing agent, air for example, is supplied to the oxidizing agent chamber 130 of each fuel cell unit 102 through the oxidizing agent supply channels 178 and unused oxidizing agent is removed from the oxidizing agent chamber 130 through the oxidizing agent removal channels 180.

In operation of the fuel cell stack 100, the CEA units 108 are, for example, at a temperature of 850° C. at which the electrolyte of each CEA unit 108 is conductive for oxygen ions. The oxidizing agent from the oxidizing agent chamber 130 picks up electrons at the cathode 111 and delivers doubly negatively charged oxygen ions to the electrolyte 109, said ions then migrating through the electrolyte 109 to the anode 113. At the anode 113, the fuel gas from the fuel gas chamber 174 is oxidized by the oxygen ions from the electrolyte 109 and thereby donates electrons to the anode 113.

The electrons freed by the reaction at the anode 113 are supplied from the anode 113 by way of the contact material 110 and the lower housing part 112 to the cathode 111 of a neighbouring fuel cell unit 102 resting on the lower surface of the contact field 138 of the lower housing part 112 and thus make the cathode reaction possible.

The lower housing part 112 and the upper housing part 106 of each fuel cell unit 102 are connected together in electrically conductive manner by the welding seams 164, 166.

However, the housings 182 of the fuel cell units 102 which succeed one another in the stack direction 104 that are formed in each case by an upper housing part 106 and a lower housing part 112 are electrically insulated from one another by the ceramic coatings 150 on the upper surface of the upper housing parts 106. Hereby, due to the brazing of the upper housing parts 106 to the lower housing parts 112 of neighbouring fuel cell units 102, a gastight connection between these components is ensured at the same time so that the oxidizing agent chambers 130 and the fuel gas chambers 174 of the fuel cell units 102 are separated in gas-tight manner from each other and from the environment of the fuel cell stack 100.

In a (not illustrated) variant of the previously described embodiment of a fuel cell stack 100, provision is made for the electrically insulating ceramic coating not to be arranged on the upper surface of the upper housing part 106, but instead, on the lower surface of the lower housing part 112.

In a further variant, provision is made for a respective electrically insulating ceramic coating to be provided on both the upper surface of the upper housing part 106 and the lower surface of the lower housing part 112.

1. A seal arrangement for a fuel cell stack which comprises a plurality of fuel cell units that succeed one another in a stack direction, wherein each of the fuel cell units comprises a housing incorporating at least one housing part consisting of a metallic material,
wherein the seal arrangement comprises at least one housing part of a first fuel cell unit consisting of a metallic material which is provided with a coating of a ceramic material, wherein the housing part of the first fuel cell unit is brazed to a housing part of a second fuel cell unit by means of a metallic braze at least one position that is provided with the ceramic coating.

2. A seal arrangement in accordance with claim 1, wherein the housing part of the first fuel cell unit comprises at least one fuel gas passage opening.

3. A seal arrangement in accordance with claim 1, wherein the housing part of the first fuel cell unit comprises at least one oxidizing agent passage opening.

4. A seal arrangement in accordance with claim 1, wherein the housing part of the first fuel cell unit comprises at least one passage opening through which, in the assembled state of the fuel cell stack, a cathode electrolyte anode unit of the first fuel cell unit is accessible for enabling electrical contact to be made by another fuel cell unit of the fuel cell stack.

5. A seal arrangement in accordance with claim 1, wherein the housing part of the first fuel cell unit is formed from a metal sheet.

6. A seal arrangement in accordance with claim 1, wherein the housing part of the first fuel cell unit is formed from a highly corrosion resistant steel.

7. A seal arrangement in accordance with claim 1, wherein the ceramic coating comprises aluminium oxide and/or titanium dioxide and/or zirconium dioxide and/or magnesium oxide.

8. A seal arrangement in accordance with claim 1, wherein the ceramic coating is produced by a thermal spraying process, in particular by an atmospheric plasma spraying process, by a vacuum plasma spraying process or by a flame spraying process.

9. A seal arrangement in accordance with claim 1, wherein the housing part of the first fuel cell unit is formed from a metallic alloy which contains an oxidizable constituent.

10. A seal arrangement in accordance with claim 9, wherein the metallic alloy contains aluminium and/or zirconium as the oxidizable constituent.

11. A seal arrangement in accordance with claim 9, wherein the ceramic coating is produced by oxidation of an oxidizable constituent of the metallic alloy.

12. A seal arrangement in accordance with claim 1, wherein the ceramic coating has a thickness of approximately 20 μm to approximately 1,000 μm.

13. A seal arrangement in accordance with claim 1, wherein the housing part of the first fuel cell unit is brazed to the housing part of the second fuel cell unit by means of a silver based braze having a copper additive.

14. A seal arrangement in accordance with claim 1, wherein the housing part of the first fuel cell unit is brazed to the housing part of the second fuel cell unit by means of a silver based braze without a copper additive.

15. A seal arrangement in accordance with claim 14, wherein the silver based braze contains an additive of copper oxide.

16. A seal arrangement in accordance with claim 1, wherein the housing part of the first fuel cell unit is brazed to the housing part of the second fuel cell unit by means of a silver based braze having a titanium additive.

17. A seal arrangement in accordance with claim 1, wherein the housing part of the first fuel cell unit is brazed to the housing part of the second fuel cell unit by means of an active braze.

18. A seal arrangement in accordance with claim 1, wherein the housing part of the first fuel cell unit that is provided with the ceramic coating is fixed to a second housing part of the first fuel cell unit.

19. A seal arrangement in accordance with claim 18, wherein the housing part of the first fuel cell unit that is provided with the ceramic coating is welded and/or brazed to the second housing part of the first fuel cell unit.

20. A seal arrangement in accordance with claim 18, wherein the second housing part of the first fuel cell unit has substantially the same shape as the housing part of the second fuel cell unit to which the housing part of the first fuel cell unit that is provided with the ceramic coating is brazed.

21. A seal arrangement in accordance with claim 18, wherein the second housing part of the first fuel cell unit comprises at least one fuel gas passage opening.

22. A seal arrangement in accordance with claim 18, wherein the second housing part of the first fuel cell unit comprises at least one oxidizing agent passage opening.

23. A seal arrangement in accordance with claim 18, wherein the second housing part of the first fuel cell unit comprises at least one contact element for the purposes of making electrical contact with a neighbouring cathode electrolyte anode unit.

24. A method of manufacturing a fuel cell stack which comprises a plurality of fuel cell units that succeed one another in a stack direction, wherein each of the fuel cell units comprises a housing incorporating at least one housing part consisting of a metallic material, comprising the following process steps:
preparing a housing part of a first fuel cell unit from a metallic material which is provided with a coating of a ceramic material;
brazing the housing part of the first fuel cell unit to a housing part of a second fuel cell unit by means of a metallic braze at least one position that is provided with the ceramic coating.

25. A method in accordance with claim 24, wherein the housing part of the first fuel cell unit that is provided with the ceramic coating is fixed to a second housing part of the first fuel cell unit.

26. A method in accordance with claim 25, wherein the housing part of the first fuel cell unit that is provided with the ceramic coating is welded and/or brazed to a second housing part of the first fuel cell unit.

27. A method in accordance with claim 24, wherein the ceramic coating is produced by a thermal spraying process, in particular by an atmospheric plasma spraying process, by a vacuum plasma spraying process or by a flame spraying process.

28. A method in accordance with claim 24, wherein there is used a housing part of the first fuel cell unit which is formed from a metallic alloy that contains an oxidizable constituent, and in that the ceramic coating on the housing part is produced by oxidation of the oxidizable constituent of the metallic alloy.

29. A seal arrangement for a fuel cell stack which comprises a plurality of fuel cell units that succeed one another in a stack direction, wherein each of the fuel cell units comprises a housing incorporating at least one housing part consisting of a metallic material,
wherein the seal arrangement comprises at least one housing part of a first fuel cell unit consisting of a metallic material which is provided with a coating of a ceramic material, wherein the housing part of the first fuel cell unit is brazed to a housing part of a second fuel cell unit by means of a silver based braze without a copper additive at least one position that is provided with the ceramic coating.

30. A seal arrangement for a fuel cell stack which comprises a plurality of fuel cell units that succeed one another in a stack direction, wherein each of the fuel cell units comprises a housing incorporating at least one housing part consisting of a metallic material,
wherein the seal arrangement comprises at least one housing part of a first fuel cell unit consisting of a metallic material which is provided with a coating of a ceramic material, wherein the housing part of the first fuel cell unit is brazed to a housing part of a second fuel cell unit by means of a silver based braze having a titanium additive at least one position that is provided with the ceramic coating.

31. A method of manufacturing a fuel cell stack which comprises a plurality of fuel cell units that succeed one another in a stack direction, wherein each of the fuel cell units comprises a housing incorporating at least one housing part consisting of a metallic material, comprising the following process steps:
preparing a housing part of a first fuel cell unit from a metallic material which is provided with a coating of a ceramic material;
brazing the housing part of the first fuel cell unit to a housing part of a second fuel cell unit by means of a silver based braze without a copper additive at least one position that is provided with the ceramic coating.

32. A method of manufacturing a fuel cell stack which comprises a plurality of fuel cell units that succeed one another in a stack direction, wherein each of the fuel cell units comprises a housing incorporating at least one housing part consisting of a metallic material, comprising the following process steps:
preparing a housing part of a first fuel cell unit from a metallic material which is provided with a coating of a ceramic material;
brazing the housing part of the first fuel cell unit to a housing part of a second fuel cell unit by means of a silver based braze having a titanium additive at least one position that is provided with the ceramic coating.
